(19) United States
(12) Patent Application Publication
(10) Pub. No.: US 2006/0225946 A1
(43) Pub. Date: Oct. 12, 2006

(54) Method of controlling reaction force device

(75) Inventors: Norio Yamazaki, Wako-shi (JP); Yoshimichi Kawamoto, Wako-shi (JP); Shigenori Takimoto, Wako-shi (JP); Masato Yuda, Wako-shi (JP)

Correspondence Address: RANKIN, HILL, PORTER & CLARK LLP, 4080 ERIE STREET, WILLOUGHBY, OH, 44094-7836, US

(73) Assignee: Honda Motor Co., Ltd., Tokyo (JP)

(21) Appl. No.: 11/385,480

(22) Filed: Mar. 21, 2006

(30) Foreign Application Priority Data
Mar. 22, 2005 (JP) 2005-082057

(51) Int. Cl. B62D 5/04

(52) U.S. Cl. 180/446

(57) ABSTRACT

A method of controlling a reaction force device which generates reaction force when a driver operates a steering wheel includes generating greater movement reaction force as a movement of a vehicle is greater, and performing correction such that movement reaction force is greater as a difference between a standard yaw rate and an actual yaw rate is larger.

The present invention claims foreign priority to Japanese patent application No. P.2005-082057, filed on Mar. 22, 2005, the contents of which is incorporated herein by reference.

### BACKGROUND OF THE INVENTION

1. Field of the Invention

The present invention relates to a method of controlling a reaction force device for a vehicle which generates reaction force when a driver operates an operation unit.

2. Description of the Background Art

An electrical power steering apparatus for reducing steering force of a driver has a reaction force device which generates auxiliary reaction force so as to increase vehicle deflection suppression performance when a disturbance, such as lateral wind or the like, is applied to a vehicle (for example, Japanese Patent Examined Publication No. JP-B-3176900)

In the related art, the reaction force device judges the movement of a vehicle based on a yaw rate, and determines auxiliary reaction force according to the yaw rate value and a vehicle speed.

However, since the reaction force device of the related art does not consider a tire grip state, when the tire grip state is changed due to a change in friction coefficient between wheels and roadway surface, such as hydroplaning or the like, it is difficult to determine optimum auxiliary reaction force for increasing vehicle deflection suppression performance.

### SUMMARY OF THE INVENTION

In view of the above described problems, it is an object of the invention to provide a method of controlling a reaction force device, which, even when a tire grip state is changed, can increase vehicle deflection suppression performance and can enhance driving stability.

In order to solve the above-described problems, according to a first aspect of the invention, there is provided a method of controlling a reaction force device (for example, an electrical motor 10 in an embodiment described below) which generates reaction force when a driver operates an operation unit (for example, a steering wheel 3 in an embodiment described below), the method comprising:
generating greater movement reaction force as a movement of a vehicle is greater; and
correcting the movement reaction force such that the movement reaction force is greater as a difference between a standard yaw rate and an actual yaw rate is larger.

According to the first aspect of the present invention, the difference between the standard yaw rate and the actual yaw rate (hereinafter, referred to as a yaw rate deviation) becomes larger as a friction coefficient defined between a wheel and roadway surface (hereinafter, the friction coefficient is referred to as a roadway surface μ) becomes smaller. Thus, if the correction is performed such that the movement reaction force is greater as the yaw rate deviation is larger, the movement reaction force can be greater as the roadway surface μ is smaller. Therefore, even when the roadway surface μ is changed, vehicle deflection suppression performance can be increased.

According to a second aspect of the invention, there is provided a method of controlling a reaction force device which generates reaction force when a driver operates an operation unit, the method comprising:
generating greater movement reaction force as a movement of a vehicle is greater; and
correcting the reaction force such that the movement reaction force is greater as steering torque relative to a steering angle is smaller.

According to the second aspect of the present invention, the steering torque relative to the steering angle becomes smaller as the roadway surface μ becomes smaller. Thus, if the correction is performed such that the movement reaction force is greater as steering torque relative to the steering angle is smaller, the movement reaction force can be greater as the roadway surface μ is smaller. Therefore, even when the roadway surface μ is changed, vehicle deflection suppression performance can be increased.

According to a third aspect of the invention, there is provided a method of controlling a reaction force device which generates reaction force when a driver operates an operation unit, the method comprising:
generating greater movement reaction force as a movement of a vehicle is greater; and
correcting the movement reaction force such that movement reaction force is greater as a friction coefficient defined between a wheel and roadway surface is smaller.

According to this configuration, the movement reaction force can be larger as the roadway surface μ is smaller, and thus, even when the roadway surface μ is changed, vehicle deflection suppression performance can be increased.

According to a fourth aspect of the invention, there is provided a method of controlling a reaction force device which generates reaction force when a driver operates an operation unit, the method comprising:
generating greater movement reaction force as a movement of a vehicle is greater; and
correcting the movement reaction force such that movement reaction force is greater as a lateral acceleration relative to a steering angle is smaller.

According to the fourth aspect of the lateral acceleration relative to the steering angle is smaller as the roadway surface μ is smaller. Thus, if the correction is performed such that the movement reaction force is greater as the lateral acceleration relative to the steering angle is smaller, the movement reaction force can be greater as the roadway surface μ is smaller. Therefore, even when the roadway surface μ is changed, vehicle deflection suppression performance can be increased.

According to the first to fourth aspects of the invention, even when the roadway surface μ is changed, vehicle deflection suppression performance can be increased, and driving stability can be enhanced.

### BRIEF DESCRIPTION OF THE DRAWINGS

FIG. 1 is a diagram showing the configuration of an electrical power steering apparatus that is suitable for executing a method of controlling a reaction force device according to the invention;

FIG. 2 is a block diagram showing a first embodiment of an electrical motor output torque control configuration in the electrical power steering apparatus;

FIG. 3 is a flowchart showing an auxiliary reaction force torque determination processing in the electrical motor output torque control configuration of the first embodiment;

FIG. 4 is a block diagram of the auxiliary reaction force torque determination processing in the first embodiment;

FIG. 5 is a block diagram showing a second embodiment of an electrical motor output torque control configuration;

FIG. 6 is a block diagram showing an auxiliary reaction force torque determination processing of the second embodiment;

FIG. 7 shows an example of a roadway surface (μ) table that is used in the auxiliary reaction force torque determination processing of the second embodiment; and

FIG. 8 shows an example of a roadway surface (μ) table that is used in an auxiliary reaction force torque determination processing of a third embodiment.

### DETAILED DESCRIPTION OF THE PREFERRED EMBODIMENTS

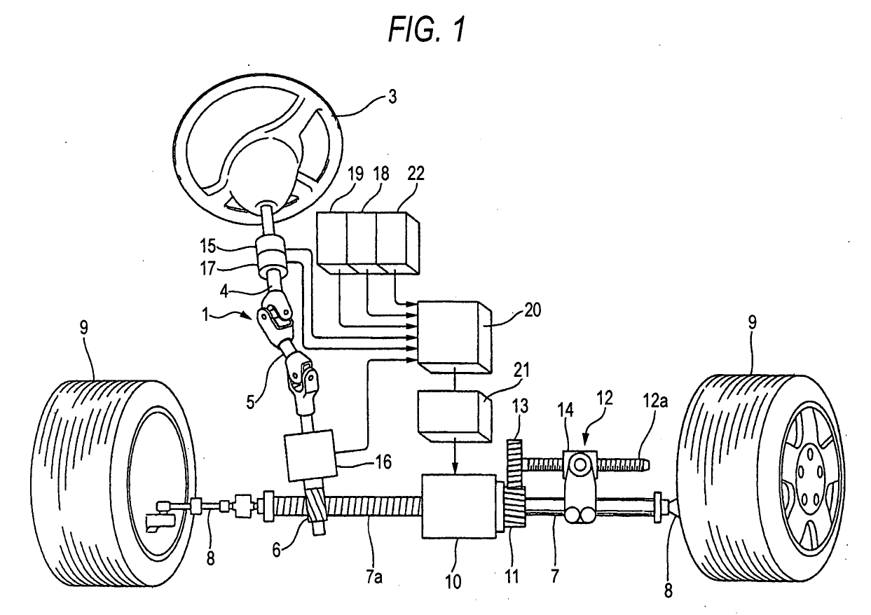

Hereinafter, embodiments of a reaction force device according to the invention will be described with reference to FIGS. 1 to 8. Moreover, in the following embodiments, an example of the invention, which is used in an electrical power steering apparatus of a vehicle, will be described.

### First Embodiment

First, a first embodiment of a method of controlling a reaction force device according to the invention will be described with reference to FIGS. 1 to 4.

The configuration of an electrical power steering apparatus will be described. The electrical power steering apparatus has a manual steering force generating mechanism 1. In the manual steering force generating mechanism 1, a steering shaft 4 integrally connected to a steering wheel (operation unit) 3 is connected to a pinion 6 of a rack-and-pinion mechanism through a connection shaft 5 having a universal joint. The pinion 6 engages with a rack 7a of a rack shaft 7 that is allowed to reciprocate in a widthwise direction of the vehicle. Front wheels 9 serving as steerable wheels are individually connected to ends of the rack shaft 7 via tie rods 8. With this configuration, when the steering wheel 3 is operated, a normal rack and pinion type steering operation is possible. Accordingly, the front wheels 9 are steered, and the vehicle can be turned. The rack shaft 7 and tie rods 8 constitute a steering mechanism.

Further, on the axis of the rack shaft 7, there is provided an electrical motor 10 for applying auxiliary steering force so as to reduce steering force generated by the manual steering force generating mechanism 1. Auxiliary steering force to be applied by the electrical motor 10 is converted into thrust force through a ball screw mechanism 12 that is substantially provided in parallel with the rack shaft 7, and is applied to the rack shaft 7. To this end, a driving helical gear 11 is integrated with a rotor of the electrical motor 10 that is inserted into the rack shaft 7. Further, a driven helical gear 13 engaging with the driving helical gear 11 is provided at an end of a screw shaft 12a of the ball screw mechanism 12, and a nut 14 of the ball screw mechanism 12 is fixed to the rack shaft 7.

On the steering shaft 4, a steering angular velocity sensor 15 for measuring a steering angular velocity of the steering shaft 4, and a steering angle sensor 17 for detecting a steering angle of the steering shaft 4 are provided. In a steering gear box (not shown) that houses the rack and pinion mechanism (6 and 7a ), a steering torque sensor 16 for detecting steering torque to be applied to the pinion 6. The steering angular velocity sensor 15 outputs electrical signals corresponding to the detected steering angular velocity to a steering control device 20. The steering angle sensor 17 outputs electrical signals corresponding to the detected steering angle to the steering control device 20. In addition, the steering torque sensor 16 outputs electrical signals corresponding to the detected steering torque to the steering control device 20. Moreover, the steering angular velocity can be calculated by time-differentiating the output signals of the steering angle sensor 17. If doing so, the steering angular velocity sensor 15 can be omitted.

Moreover, on appropriate places of the vehicle body, a yaw rate sensor (vehicle movement detecting unit) 18 for detecting a yaw rate of the vehicle, a vehicle speed sensor 19 for detecting a vehicle speed, and a lateral acceleration sensor 22 for detecting a lateral acceleration of the vehicle are mounted. The yaw rate sensor 18 outputs electrical signals corresponding to the detected yaw rate to the steering control device 20. The vehicle speed sensor 19 outputs electrical signals corresponding to the detected vehicle speed to the steering control device 20. In addition, the lateral acceleration sensor 22 outputs electrical signals corresponding to the detected lateral acceleration to the steering control device 20.

And then, the steering control device 20 determines target current to be supplied to the electrical motor 10 on the basis of control signals obtained by processing input signals from the sensors 15 to 19, and controls output torque of the electrical motor 10 by supplying the target current to the electrical motor 10 through a driving circuit 21 so as to control auxiliary steering force during a steering operation.

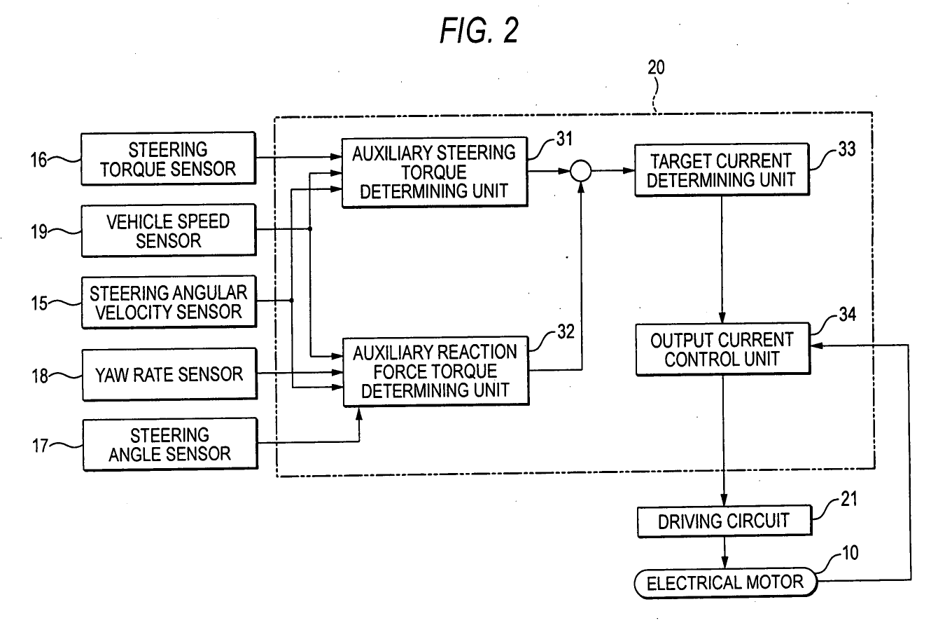

Next, the control of output torque of the electrical motor 10 in this embodiment will be described with reference to a control block diagram of FIG. 2.

The steering control device 20 includes an auxiliary steering torque determining unit 31, an auxiliary reaction force torque determining unit 32, a target current determining unit 33, and an output current control unit 34.

The auxiliary steering torque determining unit 31 determines auxiliary steering torque on the basis of the output signals of the steering angular velocity sensor 15, the steering torque sensor 16, and the vehicle speed sensor 19. A method of determining auxiliary steering torque in the auxiliary steering torque determining unit 31 is the same as that in known electrical power steering, and thus the detailed description thereof will be omitted. In summary, auxiliary steering torque is set to be smaller as the steering angular velocity is higher. Further, auxiliary steering torque is set to be greater as steering torque is greater. In addition, auxiliary steering torque is set to be smaller as the vehicle speed is higher.

The auxiliary reaction force torque determining unit 32 determines auxiliary reaction force torque TA on the basis of the output signals of the steering angular velocity 15, the steering angle sensor 17, the yaw rate sensor 18, and the vehicle speed sensor 19. A processing of determining auxiliary reaction force torque TA will be described below in detail.

The target current determining unit 33 calculates target output torque of the electrical motor 10 by subtracting auxiliary reaction force torque determined by the auxiliary reaction force torque determining unit 32 from auxiliary steering torque determined by the auxiliary steering torque determining unit 31, and determines the target current according to target output torque on the basis of the known output characteristics of the electrical motor 10.

The output current control unit 34 controls the output current to the electrical motor 10 such that actual current of the electrical motor 10 matches with the target current determined by the target current determining unit 33, and outputs the output current to the driving circuit 21.

As such, in this embodiment, target output torque of the electrical motor 10 is determined by subtracting auxiliary reaction force torque from auxiliary steering torque, and the electrical motor 10 is driven to be target output torque. Accordingly, the electrical motor 10 can be used as a reaction force device that generates reaction force when a driver operates an operation unit, as well as a steering assist device that generates assist force when the driver operates the operation unit.

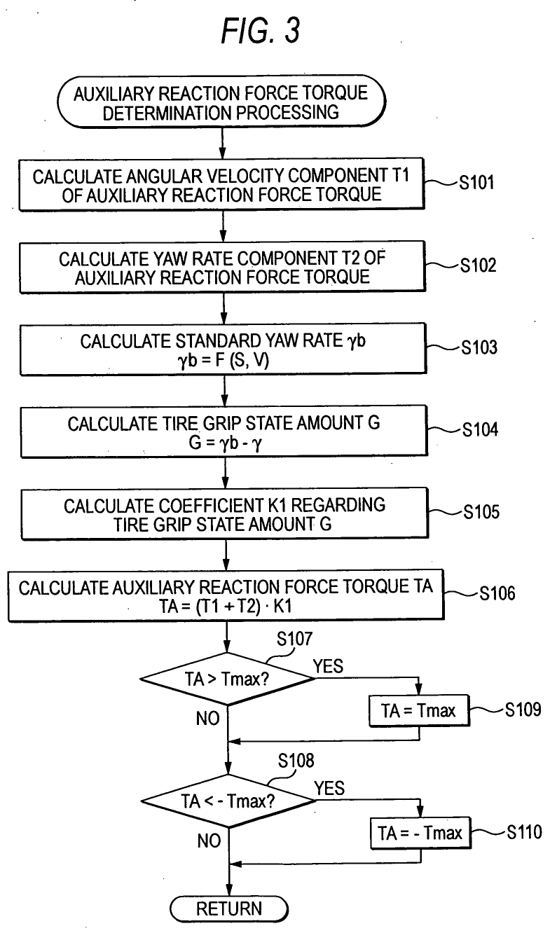

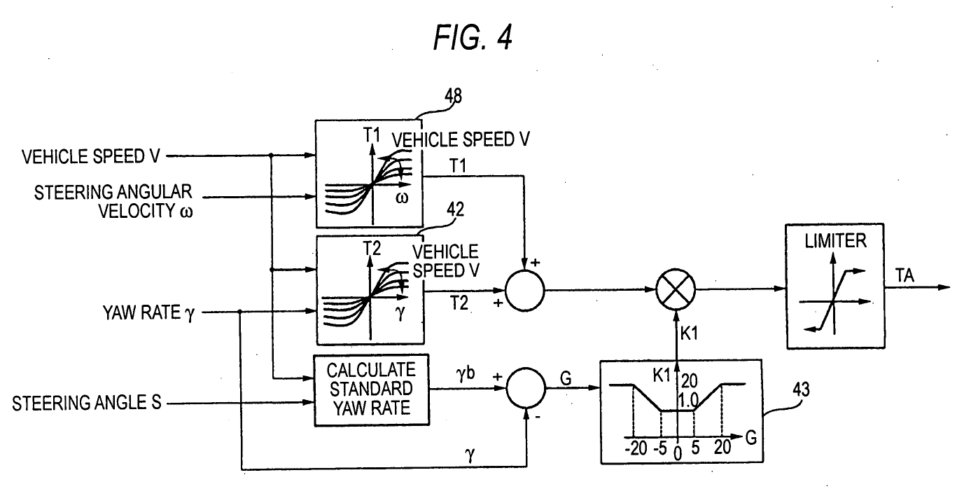

Next, a processing of determining auxiliary reaction force torque to be executed by the auxiliary reaction force torque determining unit 32 will be described with reference to a flowchart of FIG. 3 and a block diagram of FIG. 4. Moreover, a routine for an auxiliary reaction force torque determination processing shown in the flowchart of FIG. 3 is repeatedly executed by the steering control device 20 at predetermined time intervals.

First, at a step S101, auxiliary reaction force torque (hereinafter, referred to as an angular velocity component of auxiliary reaction force torque) T1 regarding the steering angular velocity ω is calculated on the basis of the output signals of the steering angular velocity sensor 15 and the vehicle speed sensor 19 by referring to a first auxiliary reaction force torque table 41 shown in FIG. 4. The first auxiliary reaction force torque table 41 is a table that addresses the steering angular velocity ω set for every vehicle speed V. The angular velocity component T1 of auxiliary reaction force torque is set to be greater as the steering angular velocity ω is higher. Further, the angular velocity component T1 of auxiliary reaction force torque is set to be greater as the vehicle speed V is higher.

Next, the process progresses to a step S102. At the step S102, auxiliary reaction force torque (hereinafter, referred to as a yaw rate component of auxiliary reaction force torque) T2 regarding the yaw rate γ is calculated on the basis of the output signals of the yaw rate sensor 18 and the vehicle speed sensor 19 by referring to a second auxiliary reaction force torque table 42 shown in FIG. 4. The second auxiliary reaction force torque table 42 is a table that addresses the yaw rate γ set for every vehicle speed V. The yaw rate component T2 of auxiliary reaction force torque is greater as the yaw rate γ is greater. Further, the yaw rate component T2 of auxiliary reaction force torque is greater as the vehicle speed V is higher.

That is, in this embodiment, with the yaw rate 65 as a parameter of the vehicle movement, auxiliary reaction force torque (movement reaction force) T2 is set to be greater as the yaw rate γ is greater, that is, the vehicle movement is greater.

Next, the process progresses to a step S103. At the step S103, a standard yaw rate γb is calculated on the basis of the output signals of the steering angle sensor 17 and the vehicle speed sensor 19. Here, the standard yaw rate γb is a yaw rate that is a reference prescribed according to the vehicle speed V and a steering angle SA.

Next, the process progresses to a step S104. At the step S104, a difference (yaw rate deviation) between an actual yaw rate γ detected by the yaw rate sensor 18 and the standard yaw rate γb calculated at the step S103 is calculated. This difference is referred to as a tire grip state amount G (G=γb−γ).

Next, the process progresses to a step S105. At the step S105, a coefficient (hereinafter, referred to as a grip state correction coefficient) K1 according to the tire grip state amount G calculated at the step S104 is calculated by referring to a grip state correction coefficient table 43 shown in FIG. 4. In this embodiment, if the grip state amount G satisfies the condition −5<G<+5, the grip state correction coefficient K1 has a constant value of 1.0. If the condition +5≦G≦20 or −5≧G≧−20 is satisfied, the grip state correction coefficient K1 is gradually increased from 1.0. Further, if the condition G>+20 or G<−20 is satisfied, the grip state correction coefficient K1 has a constant value of 2.0. However, these numeric values are examples, and the invention is not limited to these numeric values. Moreover, if the grip state amount G is positive, an under-steering state is set in which the standard yaw rate γb is larger than the actual yaw rate γ. Further, if the grip state amount G is negative, an over-steering state is set in which the actual yaw rate γ is larger than the standard yaw rate γb. The grip state amount G represents a degree of under-steering and a degree of over-steering.

Next, the process progresses to a step S106. At the step S106, auxiliary reaction force torque TA is calculated by the following expression (1) on the basis of the angular velocity component T1 of auxiliary reaction force torque calculated at the step S101, the yaw rate component T2 of auxiliary reaction force torque calculated at the step S102, and the grip state correction coefficient K1 calculated at the step S105.
TA=(T1+T2)K1 . . . (1)

That is, auxiliary reaction force torque is corrected according to the grip state amount (the degree of under-steering or the degree of over-steering). By the way, according to the relationship between the roadway surface μ (the friction coefficient between wheels and roadway surface) and the yaw rate deviation (the grip state amount G), the yaw rate deviation tends to be larger as the roadway surface μ is smaller.

Therefore, when auxiliary reaction force torque TA is calculated by the above-described expression (1), and when the yaw rate deviation (the grip state amount G) is small, the grip state correction coefficient K1 is set to 1. Accordingly, the same auxiliary reaction force torque as a usual case in which the yaw rate deviation does not occur is obtained. In contrast, when the absolute value of the yaw rate deviation (the grip state amount G) is large, the grip state correction coefficient K1 is set to 1 or more, and auxiliary reaction force torque can be greater than that in the usual case. Further, the grip state correction coefficient K1 is set to be larger as the absolute value of the yaw rate deviation (the grip state amount G) is larger. Accordingly, even when the degree of under-steering or the degree of over-steering is large, and the movement of the vehicle is likely to be instable, auxiliary reaction force torque can be greater. Therefore, the movement of the vehicle can be controlled, thereby enhancing driving stability of the vehicle.

Next, the process progresses to a step S107. At the step S107, it is judged whether or not auxiliary reaction force torque TA calculated at the step S106 is larger than the maximum value Tmax of auxiliary reaction force torque. When the judgment result at the step S107 is ‘NO’ (TA≦Tmax), the process progresses to a step S108. On the other hand, if the judgment result at the step S107 is ‘YES’ (TA>Tmax), the process progresses to a step S109. At the step S109, the maximum value Tmax of auxiliary reaction force torque is set as auxiliary reaction force torque TA, and then the process progresses to the step S108. That is, the processing of the step S109 functions as a limiter which sets auxiliary reaction force torque TA so as not to exceed the maximum value Tmax of auxiliary reaction force torque.

At the step S108, it is judged whether or not auxiliary reaction force torque TA calculated at the step S106 is smaller than the minimum value −Tmax of auxiliary reaction force torque. When the judgment result at the step S108 is ‘NO’ (TA≧−Tmax), the execution of the routine temporarily stops. When the judgment result at the step S108 is ‘YES’ (TA<−Tmax), the process progresses to a step S110. At the step S110, the minimum value −Tmax of auxiliary reaction force torque is set as auxiliary reaction force torque TA, and then the execution of the routine temporarily stops. That is, the processing of the step S110 functions as a limiter which sets auxiliary reaction force torque TA so as not to be smaller than the minimum value −Tmax of auxiliary reaction force torque.

According to the first embodiment, the roadway surface μ is estimated with the yaw rate deviation (the grip state amount G) as the parameter, and then the correction is performed such that auxiliary reaction force torque TA is greater as the yaw rate deviation is larger (that is, the roadway surface μ is smaller). Accordingly, even when the roadway surface μ is changed, vehicle deflection suppression performance can be increased. Therefore, even when the roadway surface μ is changed, driving stability of the vehicle can be enhanced.

### Second Embodiment

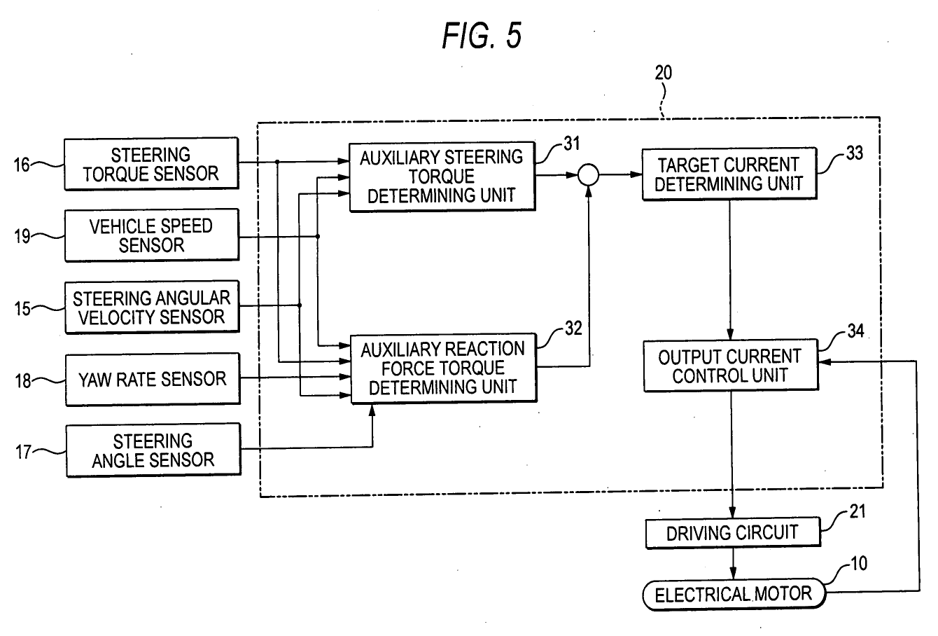

Next, a second embodiment of a method of controlling a reaction force device according to the invention will be described with reference to FIGS. 5 to 7.

The hardware configuration of an electrical power steering apparatus is the same as that in the first embodiment. Accordingly, FIG. 1 will be quoted and the description thereof will be omitted.

FIG. 5 is an output torque control block diagram of an electrical motor 10 in the second embodiment. This embodiment is different from the first embodiment in that the auxiliary reaction force torque determining unit 32 determines auxiliary reaction force torque TA on the basis of the output signals of the steering angular velocity sensor 15, the steering torque sensor 16, the steering angle sensor 17, the yaw rate sensor 18, and the vehicle speed sensor 19.

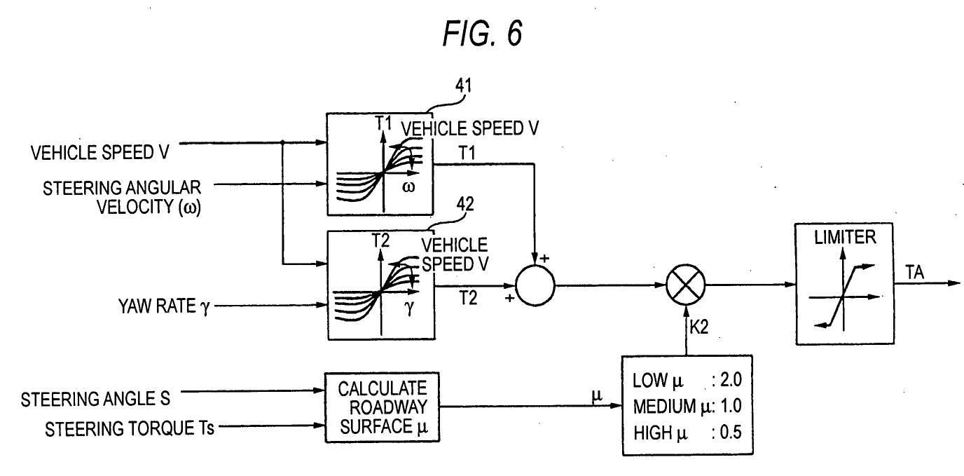

Hereinafter, a processing of determining auxiliary reaction force torque TA will be described with reference to a block diagram of FIG. 6.

First, like the first embodiment, the angular velocity component T1 of auxiliary reaction force torque is calculated on the basis of the output signals of the steering angular velocity sensor 15 and the vehicle speed sensor 19 by referring to the first auxiliary reaction force torque table 41. And then, the yaw rate component T2 of auxiliary reaction force torque is calculated on the basis of the output signals of the yaw rate sensor 18 and the vehicle speed sensor 19 by referring to the second auxiliary reaction force torque table 42. That is, similarly, in this embodiment, with the yaw rate γ as the parameter of the vehicle movement, auxiliary reaction force torque (movement reaction force) T2 is set to be greater as the yaw rate (vehicle movement) γ is greater.

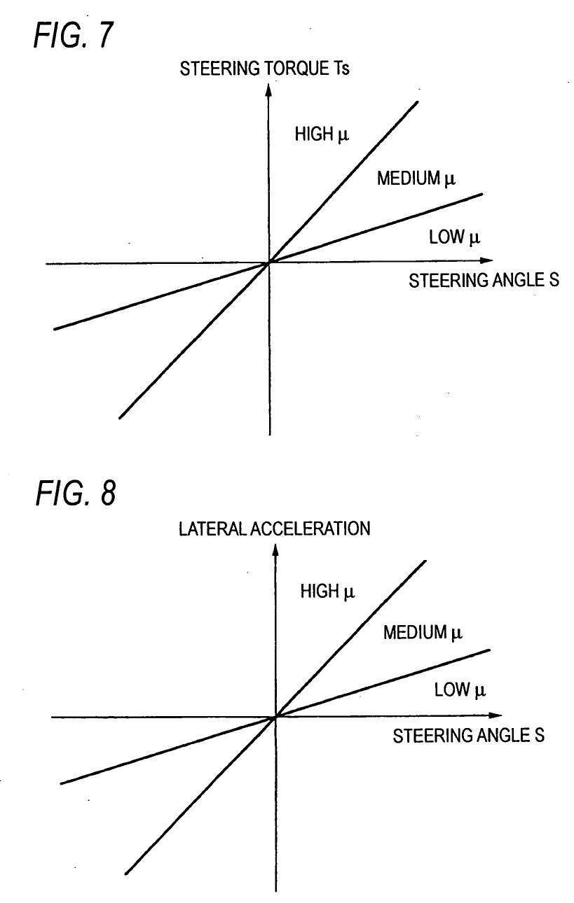

Next, the friction coefficient between wheels and roadway surface, that is, the roadway surface μ, is calculated on the basis of the output signals of the steering torque sensor 16 and the steering angle sensor 17 by referring to a roadway surface (μ) table shown in FIG. 7.

The roadway surface (μ) table is created in advance on the basis of the relationship between the steering angle and steering torque. For example, when the roadway surface μ is small, roadway surface reaction force applied to wheels is small, and thus a ratio of steering torque to the steering angle becomes small. Further, when the roadway surface μ is large, roadway surface reaction force applied to the wheels is great, and thus the ratio of steering torque to the steering angle becomes large. The roadway surface table is divided into three regions of a low μ region where the sum of steering torque to the steering angle is relatively small, a high μ region where the sum of steering torque to the steering angle is relatively large, and a medium μ region between the low μ region and the high μ region.

And then, a roadway surface (μ) correction coefficient K2 is calculated on the basis of the roadway surface μ, which is calculated on the basis of the output signals of the steering torque sensor 16 and the steering angle sensor 17. In this embodiment, when the roadway surface μ belongs to the low μ region, the roadway surface (μ) correction coefficient K2 is set to 2.0. When the roadway surface μ belongs to the medium μ region, the roadway surface (μ) correction coefficient K2 is set to 1.0. In addition, when the roadway surface μ belongs to the high μ region, the roadway surface (μ) correction coefficient K2 is set to 0.5.

However, these numeric values are examples, and the invention is not limited to these numeric values. For example, if the roadway surface μ belongs to the low μ region, the roadway surface (μ) correction coefficient K2 may be set to a predetermined value of one or more, and, if the roadway surface μ belongs to the high μ region, the roadway surface (μ) correction coefficient K2 may be set to a predetermined value of one or less. Further, the roadway surface (μ) table may be minutely divided into μ regions, and the roadway surface (μ) correction coefficients K2 may be set according to the individual regions. In addition, in order to prevent erroneous judgment, a region where the steering angle is small may be set as a dead zone, and the correction by the roadway surface μ may not be executed in the dead zone (or the roadway surface (μ) correction coefficient K2 may be set to 1.0).

Subsequently, auxiliary reaction force torque TA is calculated by the following expression (2) from the angular velocity component T1 of auxiliary reaction force torque, the yaw rate component T2 of auxiliary reaction force torque, and the roadway surface (μ) correction coefficient K2.
TA=(T1+T2)K2 . . . (2)

That is, auxiliary reaction force torque is corrected according to the states of the roadway surface μ. In the second embodiment, when the roadway surface μ belongs to the medium μ region, the roadway surface (μ) correction coefficient K2 is set to 1.0. Accordingly, auxiliary reaction force torque TA becomes an uncorrected value (T1+T2). On the other hand, when the roadway surface μ belongs to the low μ region, the roadway surface (μ) correction coefficient K2 is set to 2.0. Accordingly, auxiliary reaction force torque can be two times as much as the uncorrected value. Therefore, even when the roadway surface μ is low, and the movement of the vehicle is likely to be instable, the vehicle movement can be suppressed, and thus driving stability can be enhanced. Further, when the roadway surface μ belongs to the high μ region, the roadway surface (μ) correction coefficient K2 is set to 0.5. Accordingly, auxiliary reaction force torque can be reduced by half of the uncorrected value. Therefore, even when the roadway surface μ is high, roadway surface reaction force is greater, and steering is likely to overlap, auxiliary reaction force torque can be reduced, and steering can be prevented from overlapping.

Next, a limiter processing is executed such that auxiliary reaction force torque TA does not exceed the maximum value Tmax of auxiliary reaction force torque and is not smaller than the minimum value −Tmax of auxiliary reaction force torque, and then auxiliary reaction force torque TA is determined. The limiter processing is the same as that in the first embodiment, and thus the detailed description thereof will be omitted.

### Third Embodiment

Next, a third embodiment of a method of controlling a reaction force device according to the invention will be described with reference to FIG. 8.

In the second embodiment, the roadway surface μ is calculated on the basis of the output signals of the steering torque sensor 16 and the steering angle sensor 17. In the third embodiment, the roadway surface μ is calculated on the basis of the output signals of the steering angle sensor 17 and the lateral acceleration sensor 22 by referring to a roadway surface (μ) table shown in FIG. 8.

The roadway surface (μ) table shown in FIG. 8 is created in advance on the basis of the relationship between the lateral acceleration and the steering angle. For example, when the roadway surface μ is small, tire lateral force becomes small, and thus a ratio of the lateral acceleration to the steering angle becomes small. In contrast, when the roadway surface μ is large, tire lateral force becomes great, and thus the ratio of the lateral acceleration to the steering angle becomes large. The roadway surface table is divided into three regions of a low μ region where the ratio of the lateral acceleration to the steering angle is relatively small, a high μ region where the ratio of the lateral acceleration to the steering angle is relatively large, and a medium μ region between the low μ region and the high μ region. That is, in the third embodiment, the roadway surface (μ) table substitutes vertical steering torque in the roadway surface (μ) table of the second embodiment with the lateral acceleration. A processing, excluding the calculation of the roadway surface μ, is the same as that in the second embodiment, and thus the detailed description will be omitted.

According to the method of controlling a reaction force device of the third embodiment, even when the roadway surface μ is low and the movement of the vehicle is likely to be instable, the vehicle movement can be suppressed, and thus driving stability can be enhanced. Further, even when the roadway surface μ is high and steering is likely to overlap, auxiliary reaction force torque can be reduced, and steering can be suppressed from overlapping. Moreover, in the third embodiment, in order to prevent erroneous judgment, a region where the steering angle is small may be set as a dead zone, and the reaction force correction by the roadway surface μ may not be executed in the dead zone (or the roadway surface (μ) correction coefficient K2 may be set to 1.0).

### Other Embodiments

Moreover, the invention is not limited to the above-described embodiments.

Application of the method of controlling a reaction force device according to the invention is not limited to the electrical power steering apparatus in the embodiment described above. For example, the invention can be applied to a steering apparatus in a steer-by-wire system (SBW). The SBW is a system in which an operation unit and a steering mechanism are mechanically separated from each other. The SBW includes a reaction force motor (reaction force device) that applies reaction force to the operation unit, and a steering motor that is provided in the steering mechanism so as to generate force for turning steerable wheels.

What is claimed is:

1. A method of controlling a reaction force device which generates reaction force when a driver operates an operation unit, the method comprising:
generating greater movement reaction force as a movement of a vehicle is greater; and
correcting the movement reaction force such that the movement reaction force is greater as a difference between a standard yaw rate and an actual yaw rate is larger.

2. A method of controlling a reaction force device which generates reaction force when a driver operates an operation unit, the method comprising:
generating greater movement reaction force as a movement of a vehicle is greater; and
correcting the reaction force such that the movement reaction force is greater as steering torque relative to a steering angle is smaller.

3. A method of controlling a reaction force device which generates reaction force when a driver operates an operation unit, the method comprising:
generating greater movement reaction force as a movement of a vehicle is greater; and
correcting the movement reaction force such that movement reaction force is greater as a friction coefficient defined between a wheel and roadway surface is smaller.

4. A method of controlling a reaction force device which generates reaction force when a driver operates an operation unit, the method comprising:
generating greater movement reaction force as a movement of a vehicle is greater; and
correcting the movement reaction force such that movement reaction force is greater as a lateral acceleration relative to a steering angle is smaller.
